(19) United States
(12) Patent Application Publication
(10) Pub. No.: US 2025/0374339 A1
(43) Pub. Date: Dec. 4, 2025

(54) WIRELESS COMMUNICATION PAIRING SYSTEM AND WIRELESS COMMUNICATION PAIRING METHOD

(71) Applicant: DEXIN CORPORATION, New Taipei City (TW)

(72) Inventors: HO-LUNG LU, NEW TAIPEI CITY (TW); YUAN-JUNG CHANG, NEW TAIPEI CITY (TW)

(21) Appl. No.: 19/189,286

(22) Filed: Apr. 25, 2025

Related U.S. Application Data
(60) Provisional application No. 63/653,954, filed on May 30, 2024.

(30) Foreign Application Priority Data
Mar. 4, 2025 (TW) 114107791

(51) Int. Cl. H04W 76/10; H04W 4/80

(52) U.S. Cl. CPC H04W 76/10; H04W 4/80

(57) ABSTRACT

A wireless communication pairing system and a wireless communication pairing method are provided. The wireless communication pairing system includes a wireless transceiver and a peripheral device, the peripheral device includes a control circuit and a plurality of wireless communication modules, the control circuit is connected to the wireless communication modules and is configured to perform the following operations: pairing one of the wireless communication modules with the wireless transceiver; in response to pairing one of the wireless communication modules with the wireless transceiver, obtaining, by the wireless communication module that is paired with the wireless transceiver, a plurality of pairing records for pairing others of the wireless communication modules that have not been paired with the wireless transceiver from the wireless transceiver; pairing the others of the wireless communication modules that have not been paired with the wireless transceiver with the wireless transceiver according to the pairing records.

### CROSS-REFERENCE TO RELATED PATENT APPLICATION

This application claims the benefit of priorities to U.S. Provisional Patent Application Ser. No. 63/653,954, filed on May 30, 2024, and Taiwan Patent Application No. 114107791, filed on Mar. 4, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a wireless transmission field, and more particularly to a wireless communication pairing system and a wireless communication pairing method.

### BACKGROUND OF THE DISCLOSURE

With the advancement of information technology, electronic devices, such as mobile phones, tablet computers, laptops, desktop computers, mouse devices and keyboards, can be equipped with multiple types of wireless communication modules at the same time. Generally speaking, before two electronic devices are used to wirelessly transmit data to each other, the wireless communication module of the electronic device needs to be paired with the communication module of the other electronic device.

For example, each of the two electronic devices is equipped with a Bluetooth module and a wireless fidelity (Wi-Fi) module. When a user manually operates a BLUETOOTH module of the electronic device to pair with a BLUETOOTH module of another electronic device, pairing information for pairing with the BLUETOOTH module is not the same as pairing information for pairing a Wi-Fi module. Therefore, when the user switches from the BLUETOOTH module to the Wi-Fi module, the user needs to manually operate the Wi-Fi module of the electronic device to pair with the Wi-Fi module of another electronic device again, which causes inconvenience in use.

### SUMMARY OF THE DISCLOSURE

In response to the above-referenced technical inadequacy, the present disclosure provides a wireless communication pairing system and a wireless communication pairing method.

In order to solve the above-mentioned problem, one of the technical aspects adopted by the present disclosure is to provide a wireless communication pairing system. The wireless communication pairing system includes a wireless transceiver and a peripheral device, the peripheral device includes a control circuit and a plurality of wireless communication modules, the control circuit is connected to the wireless communication modules and the control circuit is configured to perform the following operations: pairing one of the wireless communication modules with the wireless transceiver; in response to pairing the wireless communication module with the wireless transceiver, obtaining, by the wireless communication module that has been paired with the wireless transceiver, a plurality of pairing records for pairing others of the wireless communication modules that have not been paired with the wireless transceiver from the wireless transceiver; and pairing the others of the wireless communication modules that have not been paired with the wireless transceiver with the transceiver according to the pairing records.

In order to solve the above-mentioned problem, another one of the technical aspects adopted by the present disclosure is to provide a wireless communication pairing method. The wireless communication pairing method includes: providing a wireless transceiver and a peripheral device including a plurality of wireless communication modules; pairing one of the wireless communication modules with the wireless transceiver; in response to pairing the wireless communication module with the wireless transceiver, obtaining, by the wireless communication module that has been paired with the wireless transceiver, a plurality of pairing records for pairing others of the wireless communication modules that have not been paired with the wireless transceiver from the wireless transceiver; and pairing the others of the wireless communication modules that have not been paired with the wireless transceiver with the wireless transceiver according to the pairing records.

Therefore, in the wireless communication pairing system and the wireless communication pairing method provided by the present disclosure, as long as one of the wireless communication modules of the peripheral device completes been paired with the wireless transceiver, the others of the wireless communication modules that have not been paired with the wireless transceiver can be automatically paired with the wireless transceiver, which can eliminate the trouble of repeated manual pairing operations.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a wireless communication pairing system according to a first embodiment of the present disclosure;

FIG. 2 is a function block diagram of the wireless communication pairing system of FIG. 1;

FIG. 3 is a schematic diagram of the wireless communication pairing system according to a second embodiment of the present disclosure;

FIG. 4 is a schematic diagram of the wireless communication pairing system according to a third embodiment of the present disclosure;

FIGS. 5A-5B show a flowchart of a wireless communication pairing method according to the first embodiment of the present disclosure;

FIGS. 6A-6B show a flowchart of a wireless communication pairing method according to the second embodiment of the present disclosure;

FIGS. 7A-7B show a flowchart of a wireless communication pairing method according to the third embodiment of the present disclosure;

FIGS. 8A-8B show a flowchart of a wireless communication pairing method according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

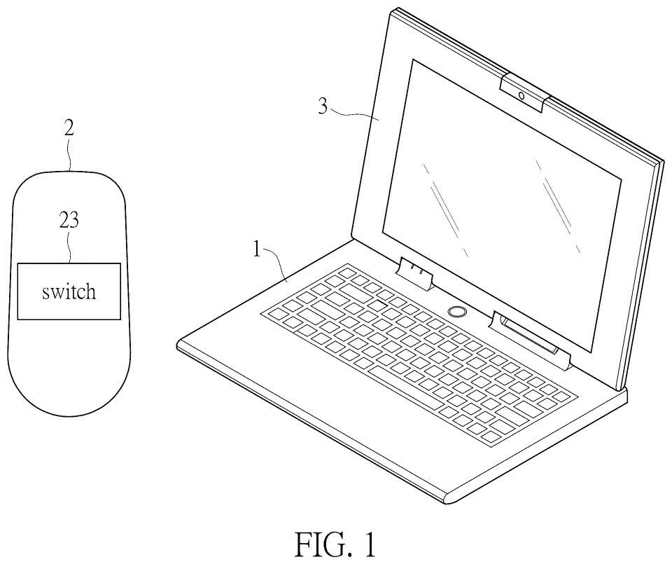

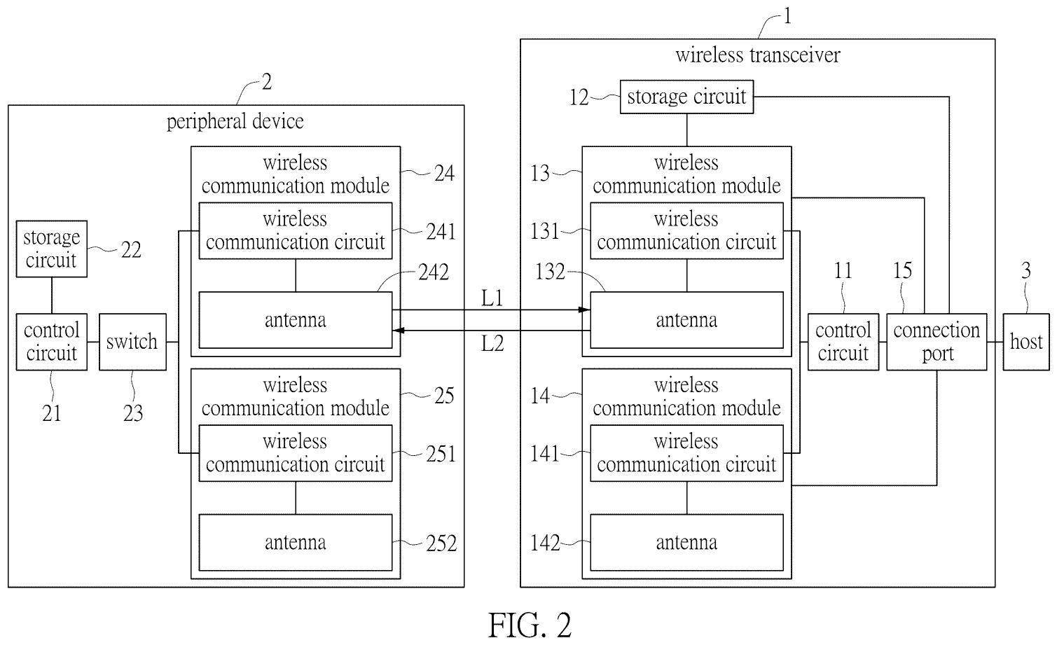

FIG. 1 is a schematic diagram of a wireless communication pairing system according to a first embodiment of the present disclosure, and FIG. 2 is a function block diagram of the wireless communication pairing system of FIG. 1. Referring to FIG. 1 and FIG. 2, the wireless communication pairing system includes a wireless transceiver 1 and a peripheral device 2. The wireless transceiver 1 is, for example, a wireless network adapter. The wireless transceiver 1 is configured to connect to a host 3 to obtain power for operations of the wireless transceiver 1. The host 3 is, for example, a tablet computer, a laptop, a desktop computer or a mobile communication device. In this embodiment, the host 3 is a laptop.

The peripheral device 2 is, for example, a wireless keyboard or a wireless mouse. In this embodiment, the peripheral device 2 is a wireless mouse, and the peripheral device 2 has a battery, and the battery provides power for the operation of the peripheral device 2.

The wireless transceiver 1 includes a control circuit 11, a storage circuit 12, a plurality of different wireless communication modules 13 and 14, and a connection port 15. The control circuit 11 is, for example, a programmable logic controller circuit, a micro-processor circuit, a micro-control circuit or other processor or controller with signal processing functions. The storage circuit 12 is, for example, a random-access memory (RAM), a read only memory (ROM), a flash memory, a hard disk, or other storage device having a data storage function. The wireless communication modules 13 and 14 are, for example, two of a BLUETOOTH module, a 2.4 GHz communication module, an ultra-wideband (UWB) module, and a Wi-Fi (Wireless Fidelity) module. The connection port 15 is, for example, a Universal Serial Bus (USB) Type-A, USB Type-B, or USB Type-C.

The control circuit 11 is connected to the storage circuit 12, the wireless communication modules 13 and 14, and the connection port 15. The connection port 15 is further connected to the storage circuit 12, the wireless communication modules 13 and 14, and the host 3. The wireless transceiver 1 obtains power for the operations of the wireless transceiver 1 from the host 3.

The storage circuit 12 stores a pairing record of the wireless communication module 13, a pairing record of the wireless communication module 14, and a plurality of verification records in advance.

The wireless communication module 13 includes a wireless communication circuit 131 and an antenna 132, in which the wireless communication circuit 131 is connected to the antenna 132. The wireless communication module 14 includes a wireless communication circuit 141 and an antenna 142, in which the wireless communication circuit 141 is connected to the antenna 142.

The peripheral device 2 includes a control circuit 21, a storage circuit 22, a switch 23, and a plurality of different wireless communication modules 24 and 25. The control circuit 21 is, for example, a programmable logic controller circuit, a micro-processor circuit, a micro-control circuit, or other processor or controller with signal processing functions. The storage circuit 22 is, for example, a random-access memory (RAM), a read only memory (ROM), a flash memory, a hard disk, or other storage device having a data storage function. The types of the two wireless communication modules 24 and 25 of the peripheral device 2 are the same as the types of the two wireless communication modules 13 and 14 of the wireless transceiver 1.

The control circuit 21 is connected to the storage circuit 22 and the switch 23, and the switch 23 is connected to the control circuit 21 and the wireless communication modules 24 and 25.

The storage circuit 22 stores a pairing record of the wireless communication module 24, a pairing record of the wireless communication module 25, and a plurality of verification records in advance.

The wireless communication module 24 includes a wireless communication circuit 241 and an antenna 242, in which the wireless communication circuit 241 is connected to the switch 23 and the antenna 242. The wireless communication module 25 includes a wireless communication circuit 251 and an antenna 252, in which the wireless communication circuit 251 is connected to the switch 23 and the antenna 252. Any one of the wireless communication circuits 241 and 251 includes, for example, a processor, a radio frequency circuit, a baseband circuit, and a media access control circuit. The processor is connected to the media access control circuit, the media access control circuit is connected to the baseband circuit, the baseband circuit is connected to the radio frequency circuit, and the radio frequency circuit is connected to the antenna. Data of the processor can be processed sequentially by the media access control circuit, the baseband circuit and the radio frequency circuit to generate a radio frequency signal to the antenna. The radio frequency circuit can receive a radio frequency signal, and the radio frequency signal is processed in sequence by the radio frequency signal circuit, the baseband circuit and the media access control circuit, and the media access control circuit transmits processed data to the processor.

A user can operate the switch 23 to connect the control circuit 21 to the wireless communication module 24 or to the wireless communication module 25. When the control circuit 21 is connected to the wireless communication module 24, the control circuit 21 controls the wireless communication module 24 to transmit a wireless signal. When the control circuit 21 is connected to the wireless communication module 25, the control circuit 21 controls the wireless communication module 25 to transmit a wireless signal. In this embodiment, the control circuit 21 of the peripheral device 2 is connected to the wireless communication module 24.

The control circuit 21 of the peripheral device 2 accesses the storage circuit 22 and controls the wireless communication circuit 241 to transmit a first signal L1 to the wireless transceiver 1 through the antenna 242, in which the first signal L1 includes the pairing record of the wireless communication module 24 and the pairing record of the wireless communication module 25. The pairing record of the wireless communication module 24 includes communication protocol information, identity information and configuration information of the wireless communication module 24. The pairing record of the wireless communication module 25 includes the communication protocol information, identity information and configuration information of the wireless communication module 25. For example, when the wireless communication module is a BLUETOOTH module, a pairing record of the BLUETOOTH module includes a media access control address and a device name. When the wireless communication module is a Wi-Fi module, a pairing record of the Wi-Fi module includes a service set identifier and a device name.

Next, the antenna 132 of the wireless transceiver 1 receives the first signal L1, and the wireless communication circuit 131 transmits the first signal L1 to the control circuit 11 of the wireless transceiver 1. The control circuit 11 determines whether the pairing record of the wireless communication module 24 and the pairing record of the wireless communication module 25 match two of the verification records stored in the storage circuit 12, respectively.

When the pairing record of the wireless communication module 24 and the pairing record of the wireless communication module 25 match two of the verification records stored in the storage circuit 12, respectively, the control circuit 11 of the wireless transceiver 1 controls the wireless communication circuit 131 to send a second signal L2 to the peripheral device 2 through the antenna 132, in which the second signal L2 includes the pairing record of the wireless communication module 13 and the pairing record of the wireless communication module 14.

Next, the antenna 242 of the peripheral device 2 receives the second signal L2, and the wireless communication circuit 241 transmits the second signal L2 to the control circuit 21 of the peripheral device 2. The control circuit 21 determines whether the pairing record of the wireless communication module 13 and the pairing record of the wireless communication module 14 match two of the verification records stored in the storage circuit 22, respectively.

When the pairing record of the wireless communication module 13 and the pairing record of the wireless communication module 14 match two of the verification records stored in the storage circuit 22, respectively, the wireless communication modules 24 and 25 of the peripheral device 2 are paired with the wireless communication modules 13 and 14 of the wireless transceiver 1, respectively.

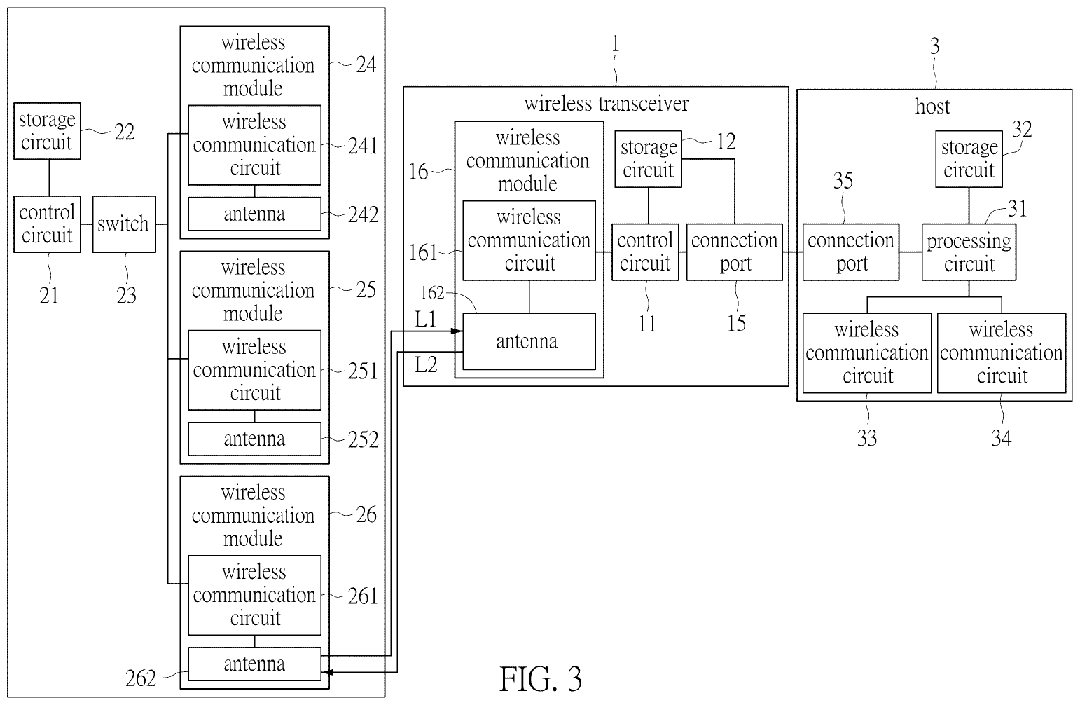

FIG. 3 is a schematic diagram of the wireless communication pairing system according to a second embodiment of the present disclosure, referring to FIG. 3, the wireless communication pairing system includes the wireless transceiver 1, the peripheral device 2, and a host 3. The wireless transceiver 1 includes the control circuit 11, the storage circuit 12, a connection port 15, and a wireless communication module 16. The storage circuit 12 stores a pairing record of the wireless communication module 16 and a plurality of verification records in advance. The wireless communication module 16 includes a wireless communication circuit 161 and an antenna 162. The wireless communication circuit 161 is connected to the antenna 162.

The peripheral device 2 includes the control circuit 21, the storage circuit 22, the switch 23, the wireless communication modules 24 and 25, and a wireless communication module 26, and the host 3 includes a processing circuit 31, a storage circuit 32, a plurality of wireless communication modules 33 and 34 and a connection port 35.

In this embodiment, the wireless communication module 16 of the wireless transceiver 1 is a 2.4 GHz communication module, the wireless communication modules 24, 25 and 26 of the peripheral device 2 are respectively a BLUETOOTH module, a Wi-Fi module and a 2.4 GHz communication module, and the wireless communication modules 33 and 34 of the host 3 are a BLUETOOTH module and a Wi-Fi module, respectively.

The control circuit 11 of the wireless transceiver 1 is connected to the storage circuit 12, the connection port 15 and the wireless communication circuit 161. The connection port 15 is further connected to the storage circuit 12, the wireless communication module 16 and the connection port 35 of the host 3.

The control circuit 21 of the peripheral device 2 is connected to the storage circuit 22, the switch 23 and the wireless communication modules 24, 25 and 26, and the switch 23 is connected to the control circuit 21 and the wireless communication modules 24, 25 and 26. The storage circuit 22 stores the pairing record of the wireless communication module 24, the pairing record of the wireless communication module 25, a pairing record of the wireless communication module 26 and a plurality of verification records in advance.

The wireless communication module 26 includes a wireless communication circuit 261 and an antenna 262, in which the wireless communication circuit 261 is connected to the switch 23 and the antenna 262.

The processing circuit 31 of the host 3 is connected to the storage circuit 32, the wireless communication modules 33 and 34 and the connection port 35. The storage circuit 32 stores a pairing record of the wireless communication module 33 and a pairing record of the wireless communication module 34 in advance. The processing circuit 31 is configured to transmit the pairing record of the wireless communication module 33 and the pairing record of the wireless communication module 34 to the control circuit 11 of the wireless transceiver 1, and the control circuit 11 of the wireless transceiver 1 stores the pairing record of the wireless communication module 33 and the pairing record of the wireless communication module 34 in the storage circuit 12.

The control circuit 21 of the peripheral device 2 accesses the storage circuit 22 and controls the wireless communication circuit 261 to transmit the first signal L1 to the wireless transceiver 1 through the antenna 262, in which the first signal L1 includes the pairing record of the wireless communication module 24, the pairing record of the wireless communication module 25, and the pairing record of the wireless communication module 26.

The antenna 162 of the wireless transceiver 1 receives the first signal L1, and the wireless communication circuit 161 transmits the first signal L1 to the control circuit 11 of the wireless transceiver 1. The control circuit 11 determines whether the pairing record of the wireless communication module 24, the pairing record of the wireless communication module 25, and the pairing record of the wireless communication module 26 match three of the verification records stored in the storage circuit 12, respectively.

When the pairing record of the wireless communication module 24, the pairing record of the wireless communication module 25 and the pairing record of the wireless communication module 26 match three of the verification records stored in the storage circuit 12, respectively, the control circuit 11 of the wireless transceiver 1 accesses the storage circuit 12 and controls the wireless communication circuit 161 to send the second signal L2 to the peripheral device 2 through the antenna 162, in which the second signal L2 includes the pairing record of the wireless communication module 16 of the wireless transceiver 1, a pairing record of the wireless communication module 33 of the host 3 and a pairing record of the wireless communication module 34 of the host 3.

The antenna 262 of the peripheral device 2 receives the second signal L2, and the wireless communication circuit 261 transmits the second signal L2 to the control circuit 21 of the peripheral device 2. The control circuit 21 determines whether the pairing record of the wireless communication module 16, the pairing record of the wireless communication module 33, and the pairing record of the wireless communication module 34 match three of the verification records stored in the storage circuit 22, respectively.

When the pairing record of the wireless communication module 16, the pairing record of the wireless communication module 33 and the pairing record of the wireless communication module 34 match three of the verification records stored in the storage circuit 22, respectively, the wireless communication modules 24 and 25 of the peripheral device 2 are paired with the wireless communication modules 33 and 34 of the host 3 respectively, and the wireless communication module 26 of the peripheral device 2 is paired with the wireless communication module 16 of the wireless transceiver 1.

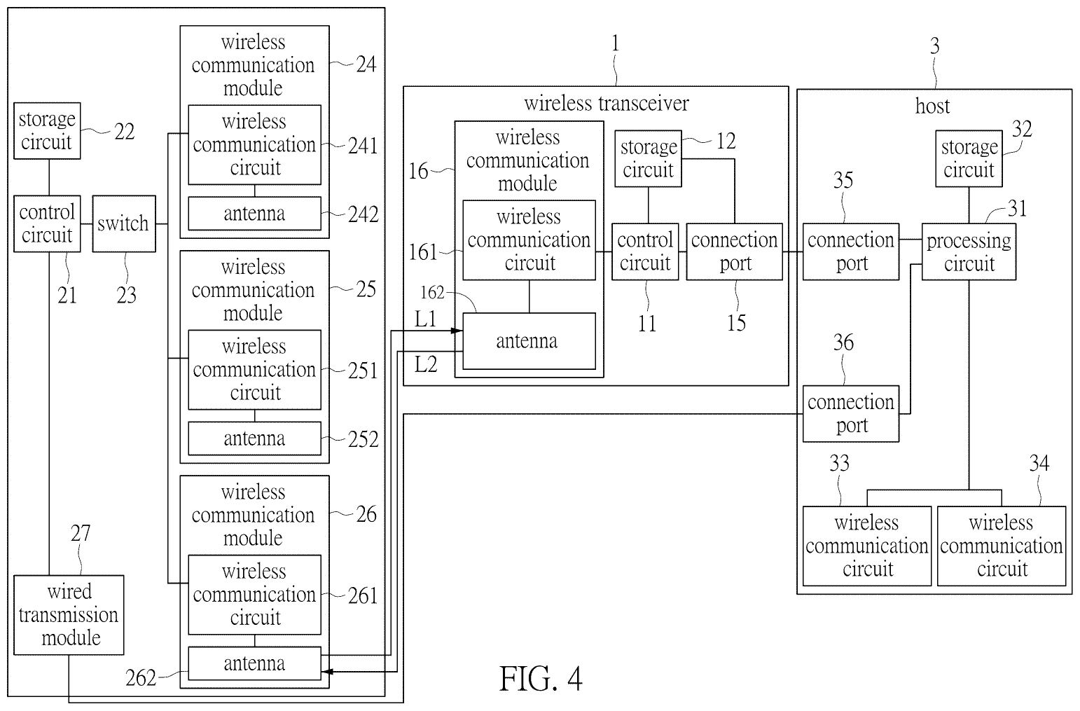

FIG. 4 is a schematic diagram of the wireless communication pairing system according to a third embodiment of the present disclosure, referring to FIG. 4, the wireless transceiver 1 includes the control circuit 11, the storage circuit 12, the connection port 15 and the wireless communication module 16. The storage circuit 12 stores the pairing record of the wireless communication module 16 and the plurality of verification records in advance. The control circuit 11 is connected to the storage circuit 12, the connection port 15 and the wireless communication module 16. In this embodiment, the wireless communication module 16 is an ultra-wideband (UWB) communication module.

The peripheral device 2 includes the control circuit 21, the storage circuit 22, the switch 23, the wireless communication modules 24, 25 and 26 and a wired transmission module 27. The storage circuit 22 stores the pairing record of wireless communication module 24, the pairing record of wireless communication module 25, the pairing record of wireless communication module 26 and the verification records. The control circuit 21 is connected to the storage circuit 22, the switch 23, the wireless communication modules 24, 25 and 26 and the wired transmission module 27, and the switch 23 is connected to the control circuit 21 and the wireless communication modules 24, 25 and 26. In this embodiment, the wireless communication module 24 is a BLUETOOTH module, the wireless communication module 25 is a Wi-Fi module, and the wireless communication module 26 is an ultra-wideband (UWB) module.

The host 3 includes the processing circuit 31, the storage circuit 32, the wireless communication modules 33 and 34, the connection port 35, and a connection port 36. The storage circuit 32 stores the pairing record of the wireless communication module 33 and the pairing record of the wireless communication module 34, and the processing circuit 31 is connected to the storage circuit 32, the wireless communication modules 33 and 34 and the connection ports 35 and 36. In this embodiment, the wireless communication module 33 is a BLUETOOTH module, and the wireless communication module 34 is a Wi-Fi module.

The connection port 15 of the wireless transceiver 1 is connected to the connection port 35 of the host 3, and the wired transmission module 27 of the peripheral device 2 is connected to the connection port 36 of the host 3.

The control circuit 21 of the peripheral device 2 accesses the storage circuit 22 and controls the wireless communication circuit 261 to transmit the first signal L1 to the wireless transceiver 1 through the antenna 262, in which the first signal L1 includes the pairing record of the wireless communication module 26.

The antenna 162 of the wireless transceiver 1 receives the first signal L1, and the wireless communication circuit 161 transmits the first signal L1 to the control circuit 11 of the wireless transceiver 1. The control circuit 11 determines whether the pairing record of the wireless communication module 26 matches one of the verification records stored in the storage circuit 12.

When the pairing record of the wireless communication module 26 matches one of the verification records stored in the storage circuit 12, the control circuit 11 of the wireless transceiver 1 controls the wireless communication circuit 161 to send the second signal L2 to the peripheral device 2 via the antenna 162, in which the second signal L2 includes the pairing record of the wireless communication module 16.

The antenna 262 of the peripheral device 2 receives the second signal L2, and the wireless communication circuit 241 transmits the second signal L2 to the control circuit 21 of the peripheral device 2. The control circuit 21 determines whether the pairing record of the wireless communication module 16 matches one of the verification records stored in the storage circuit 22.

When the pairing record of the wireless communication module 16 matches one of the verification records stored in the storage circuit 22, the wireless communication module 26 of the peripheral device 2 is paired with the wireless communication module 16 of the wireless transceiver 1.

The control circuit 21 of the peripheral device 2 transmits the pairing record of the wireless communication module 24 and the pairing record of the wireless communication module 25 to the host 3 via the wired transmission module 27.

The processing circuit 31 of the host 3 determines whether the pairing record of the wireless communication module 24 and the pairing record of the wireless communication module 25 match two of the verification records stored in the storage circuit 32. When the pairing record of the wireless communication module 24 and the pairing record of the wireless communication module 25 match two of the verification records stored in the storage circuit 32, respectively, the processing circuit 31 of the host 3 transmits the pairing record of the wireless communication module 33 and the pairing record of the wireless communication module 34 to the control circuit 21 of the peripheral device 2 via the wired transmission module 27.

The control circuit 21 of the peripheral device 2 determines whether the pairing record of the wireless communication module 33 and the pairing record of the wireless communication module 34 match two of the verification records stored in the storage circuit 22, respectively.

When the pairing record of the wireless communication module 33 and the pairing record of the wireless communication module 34 match two of the verification records stored in the storage circuit 22, respectively, the wireless communication modules 24 and 25 of the peripheral device 2 are paired with the wireless communication modules 33 and 34 of the host 3, respectively.

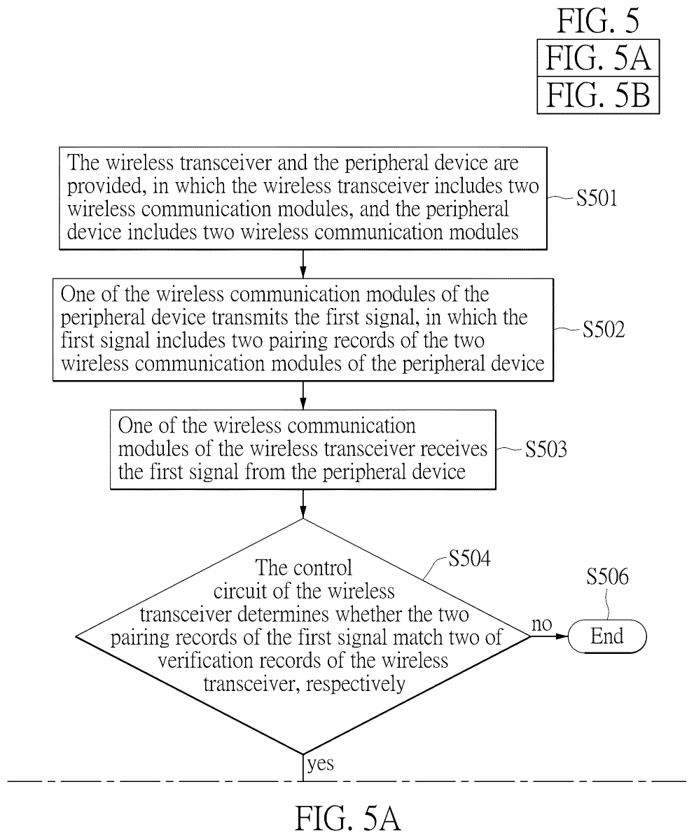

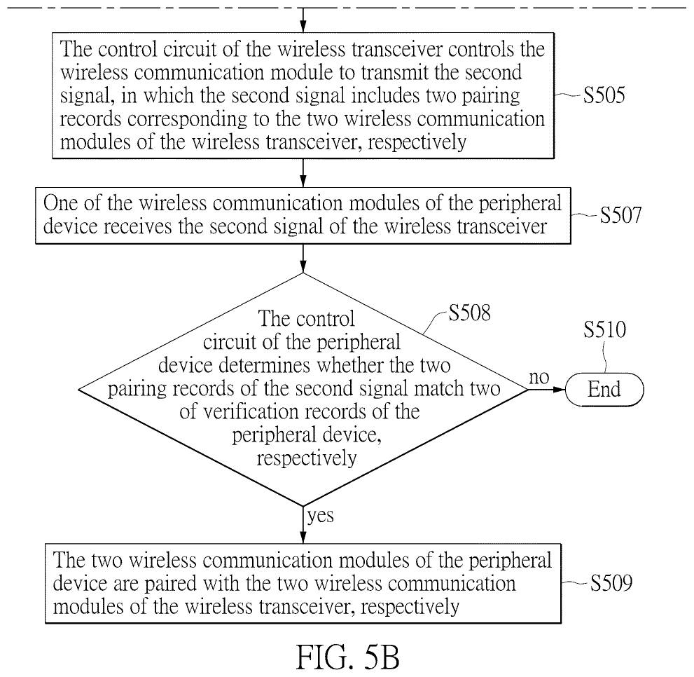

FIGS. 5A-5B show a flowchart of a wireless communication pairing method according to the first embodiment of the present disclosure. Referring to FIG. 5, in step S501, the wireless transceiver 1 and the peripheral device 2 are provided, in which the wireless transceiver 1 includes the two wireless communication modules 13 and 14, and the peripheral device 2 includes the two wireless communication modules 24 and 25.

In step S502, the wireless communication modules 24 of the peripheral device 2 transmits the first signal L1, in which the first signal L1 includes the pairing record of the wireless communication module 24 of the peripheral device 2 and the pairing record of the wireless communication module 25 of the peripheral device 2. Specifically, the storage circuit 22 of the peripheral device 2 stores the pairing record of the wireless communication module 24 and the pairing record of the wireless communication module 25 in advance.

In step S503, the wireless communication modules 13 of the wireless transceiver 1 receives the first signal L1 from the peripheral device 2.

In step S504, the control circuit 11 of the wireless transceiver 1 determines whether the two pairing records of the first signal L1 match two of verification records of the wireless transceiver 1, respectively. If yes, the wireless communication pairing method proceeds to step S505, if not, the wireless communication pairing method ends (step S506). Specifically, the storage circuit 12 of the wireless transceiver 1 stores the verification records in advance.

In step S505, the control circuit 11 of the wireless transceiver 1 controls the wireless communication module 13 to transmit the second signal L2, in which the second signal L2 includes the pairing record corresponding to the wireless communication module 13 of the wireless transceiver 1 and the paring record corresponding to the wireless communication module 14 of the wireless transceiver 1. Specifically, the storage circuit 12 of the wireless transceiver 1 stores the pairing record of the wireless communication module 13 and the pairing record of the wireless communication module 14 in advance.

In step S507, the wireless communication module 24 of the peripheral device 2 receives the second signal L2 of the wireless transceiver 1.

In step S508, the control circuit 21 of the peripheral device 2 determines whether the two pairing records of the second signal L2 match two of the verification records of the peripheral device 2, respectively. If yes, the wireless communication pairing method proceeds to step S509, if not, the wireless communication pairing method ends (step S510). Specifically, the storage circuit 22 of the peripheral device 2 stores the verification records in advance.

In step S509, the wireless communication modules 24 and 25 of the peripheral device 2 are paired with the wireless communication modules 13 and 14 of the wireless transceiver 1, respectively.

Through the wireless communication pairing method of FIG. 5, after one of the wireless communication modules of the peripheral device 2 is paired with the wireless transceiver 1, others of the wireless communication modules that have not been paired with the wireless transceiver 1 are automatically paired with the wireless transceiver 1, which can eliminate the trouble of repeated manual pairing operations.

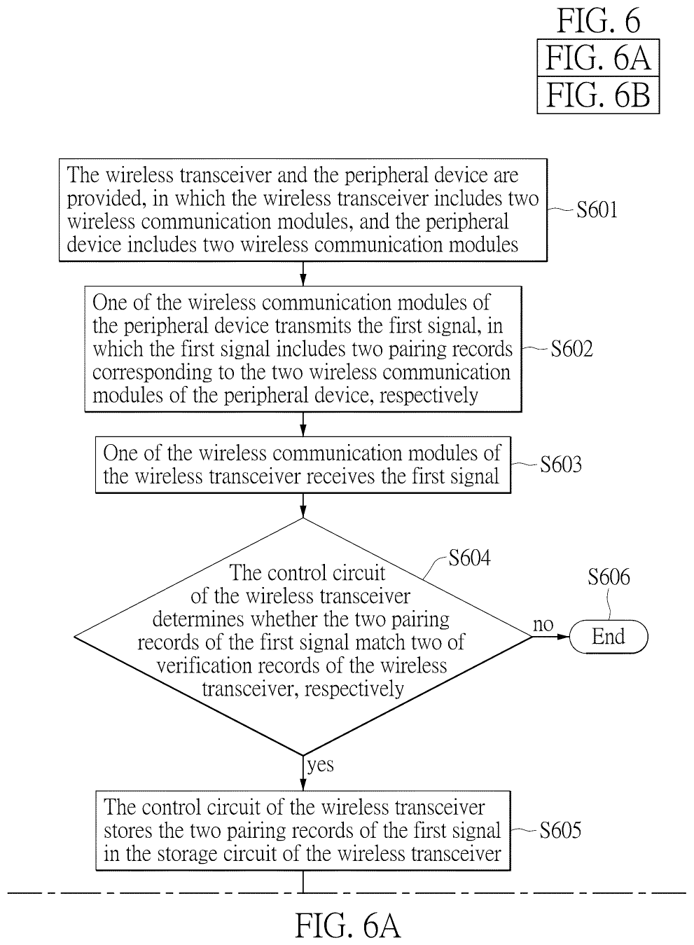

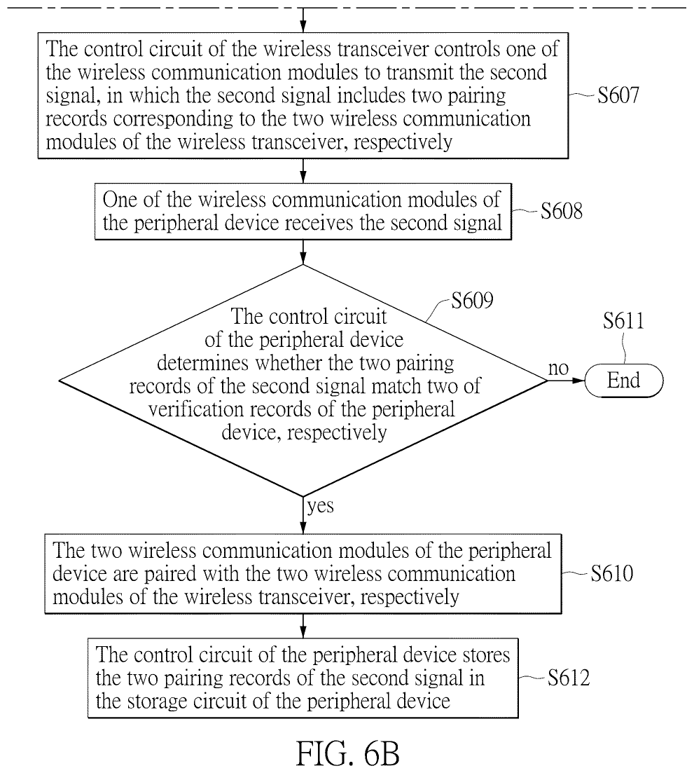

FIGS. 6A-6B show a flowchart of a wireless communication pairing method according to the second embodiment of the present disclosure. Referring to FIG. 6, in step S601, the wireless transceiver 1 and the peripheral device 2 are provided, in which the wireless transceiver 1 includes the two wireless communication modules 13 and 14, and the peripheral device 2 includes the two wireless communication modules 24 and 25.

In step S602, the wireless communication modules 24 of the peripheral device 2 transmits the first signal L1, in which the first signal L1 includes the pairing record corresponding to the wireless communication module 24 of the peripheral device 2 and the pairing record corresponding to the wireless communication module 25 of the peripheral device 2.

In step S603, the wireless communication modules 13 of the wireless transceiver 1 receives the first signal L1.

In step S604, the control circuit 11 of the wireless transceiver 1 determines whether the two pairing records of the first signal L1 match two of verification records of the wireless transceiver 1, respectively. If yes, the wireless communication pairing method proceeds to step S605, if not, the wireless communication pairing method ends (step S606).

In step S605, the control circuit 11 of the wireless transceiver 1 stores the two pairing records of the first signal L1 in the storage circuit 12 of the wireless transceiver 1.

In step S607, the control circuit 11 of the wireless transceiver 1 controls the wireless communication module 13 to transmit the second signal L2, in which the second signal L2 includes the pairing record corresponding to the wireless communication module 13 of the wireless transceiver 1 and the pairing record corresponding to the wireless communication module 14 of the wireless transceiver 1.

In step S608, the wireless communication module 24 of the peripheral device 2 receives the second signal L2.

In step S609, the control circuit 21 of the peripheral device 2 determines whether the two pairing records of the second signal L2 match two of verification records of the peripheral device 2, respectively. If yes, the wireless communication pairing method proceeds to step S610, if not, the wireless communication pairing method ends (step S611).

In step S610, the wireless communication modules 24 and 25 of the peripheral device 2 are paired with the wireless communication modules 13 and 14 of the wireless transceiver 1, respectively.

In step S612, the control circuit 21 of the peripheral device 2 stores the pairing records of the second signal L2 in the storage circuit 22 of the peripheral device 2.

Through the wireless communication pairing method of FIG. 6, since the pairing records stored in the wireless transceiver 1 have been paired with the pairing records stored in the peripheral device 2, even if the wireless transceiver 1 is connected to a different host, the peripheral device 2 does not need to be paired with the wireless transceiver 1 again and can immediately establish a wireless connection with the wireless transceiver 1.

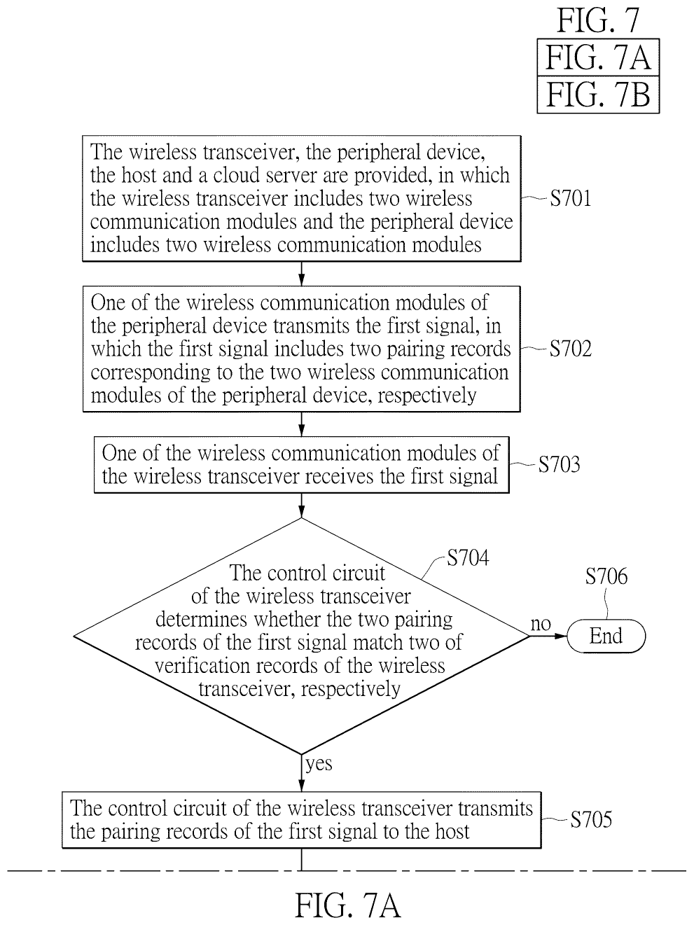

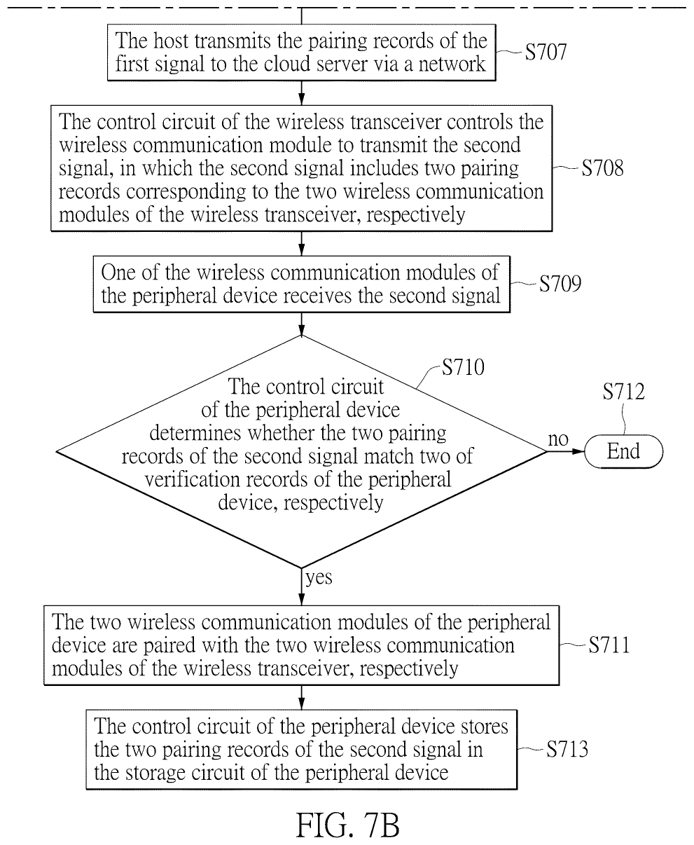

FIGS. 7A-7B show a flowchart of a wireless communication pairing method according to a third embodiment of the present disclosure. Referring to FIG. 7, in step S701, the wireless transceiver 1, the peripheral device 2, the host 3 and a cloud server are provided, in which the wireless transceiver 1 includes the wireless communication modules 13 and 14, and the peripheral device 2 includes the wireless communication modules 24 and 25.

In step S702, the wireless communication modules 24 of the peripheral device 2 transmits the first signal L1, in which the first signal L1 includes the pairing record corresponding to the wireless communication module 24 of the peripheral device 2 and the pairing record corresponding to the wireless communication module 25 of the peripheral device 2.

In step S703, the wireless communication modules 13 of the wireless transceiver 1 receives the first signal L1.

In step S704, the control circuit 11 of the wireless transceiver 1 determines whether the two pairing records of the first signal L1 match two of verification records of the wireless transceiver 1, respectively. If yes, the wireless communication pairing method proceeds to step S705, if not, the wireless communication pairing method ends (step S706).

In step S705, the control circuit 11 of the wireless transceiver 1 transmits the pairing records of the first signal L1 to the host 3.

In step S707, the host 3 transmits the pairing records of the first signal L1 to the cloud server via a network.

In step S708, the control circuit 11 of the wireless transceiver 1 controls the wireless communication module 13 to transmit the second signal L2, in which the second signal L2 includes the pairing record corresponding to the wireless communication module 13 of the wireless transceiver 1 and the pairing record corresponding to the wireless communication module 14 of the wireless transceiver 1.

In step S709, the wireless communication module 24 of the peripheral device 2 receives the second signal L2.

In step S710, the control circuit 21 of the peripheral device 2 determines whether the two pairing records of the second signal L2 match two of verification records of the peripheral device 2, respectively. If yes, the wireless communication pairing method proceeds to step S711, if not, the wireless communication pairing method ends (step S712).

In step S711, the wireless communication modules 24 and 25 of the peripheral device 2 are paired with the wireless communication modules 13 and 14 of the wireless transceiver 1, respectively.

In step S713, the control circuit 21 of the peripheral device 2 stores the two pairing records of the second signal L2 in the storage circuit 22 of the peripheral device 2.

Through the wireless communication pairing method of FIG. 7, since the pairing records stored in the peripheral device 2 have been paired with the pairing records stored in the cloud server, the wireless transceiver 1 can immediately establish a wireless connection with the peripheral device 2 as long as it downloads the pairing records from the cloud server.

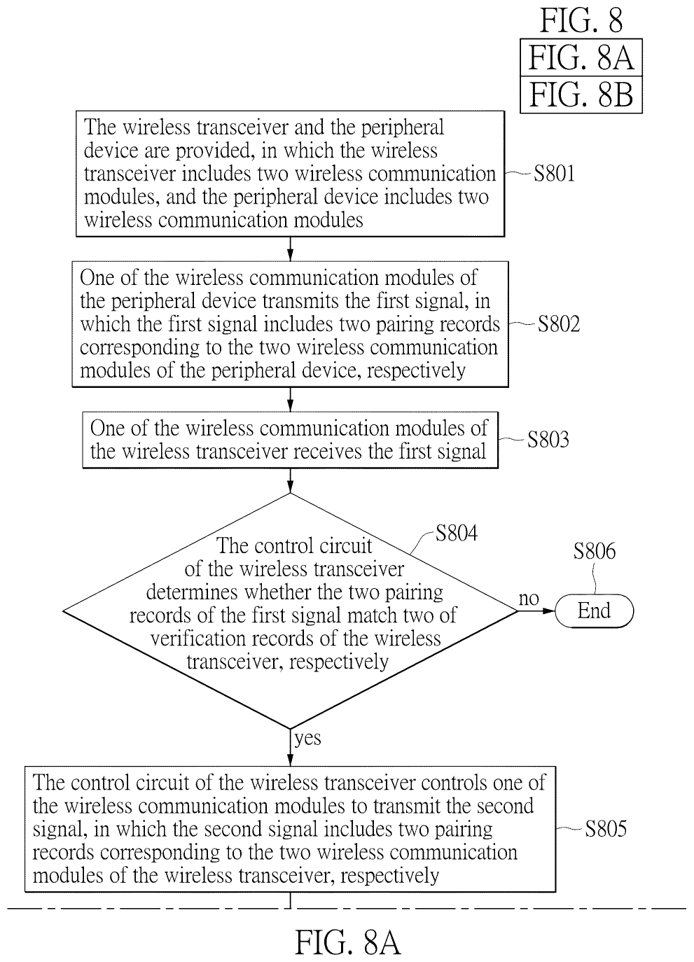

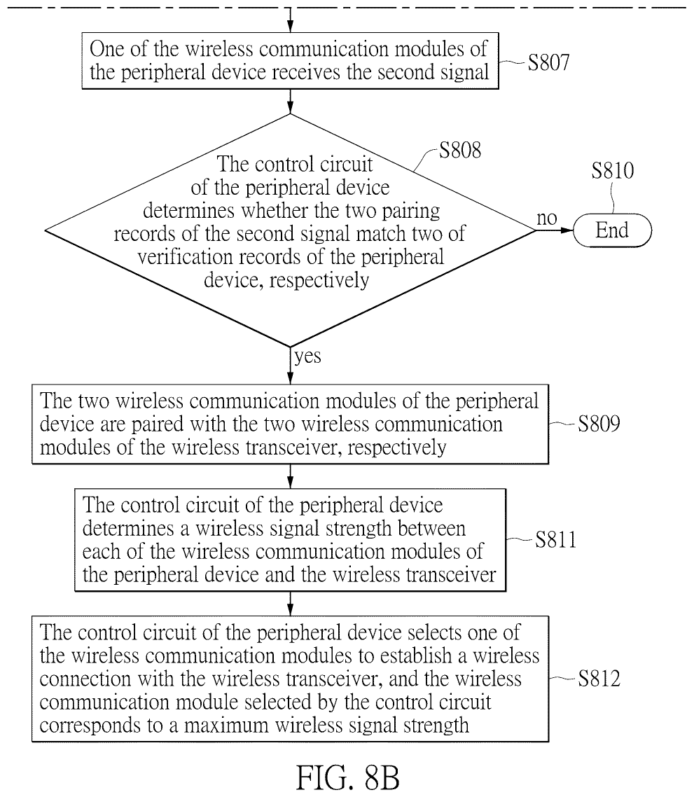

FIGS. 8A-8B show a flowchart of a wireless communication pairing method according to a fourth embodiment of the present disclosure. Referring to FIG. 8, in step S801, the wireless transceiver 1 and the peripheral device 2 are provided, in which the wireless transceiver 1 includes the two wireless communication modules 13 and 14, and the peripheral device 2 includes the two wireless communication modules 24 and 25.

In step S802, the wireless communication modules 24 of the peripheral device 2 transmits the first signal L1, in which the first signal L1 includes the pairing record corresponding to the wireless communication module 24 of the peripheral device 2 and the pairing record corresponding to the wireless communication module 25 of the peripheral device 2.

In step S803, the wireless communication modules 13 of the wireless transceiver 1 receives the first signal L1.

In step S804, the control circuit 11 of the wireless transceiver 1 determines whether the two pairing records of the first signal L1 match two of verification records of the wireless transceiver 1, respectively. If yes, the wireless communication pairing method proceeds to step S805, if not, the wireless communication pairing method ends (step S806).

In step S805, the control circuit 11 of the wireless transceiver 1 controls the wireless communication module 13 to transmit the second signal L2, in which the second signal L2 includes the pairing record corresponding to the wireless communication module 13 of the wireless transceiver 1 and the pairing record corresponding to the wireless communication module 14 of the wireless transceiver 1.

In step S807, the wireless communication module 24 of the peripheral device 2 receives the second signal L2.

In step S808, the control circuit 21 of the peripheral device 2 determines whether the two pairing records of the second signal L2 match two of verification records of the peripheral device 2, respectively. If yes, the wireless communication pairing method proceeds to step S809, if not, the wireless communication pairing method ends (step S810).

In step S809, the wireless communication modules 24 and 25 of the peripheral device 2 are paired with the wireless communication modules 13 and 14 of the wireless transceiver 1, respectively.

In step S811, the control circuit 21 of the peripheral device 2 determines a wireless signal strength between each of the wireless communication modules 24 and 25 of the peripheral device 2 and the wireless transceiver 1.

In step S812, the control circuit 21 of the peripheral device 2 selects the wireless communication modules 24 to establish a wireless connection with the wireless transceiver 1, and the wireless communication module 24 selected by the control circuit 21 corresponds to a maximum wireless signal strength.

Through the wireless communication pairing method of FIG. 8, since all the wireless communication modules of the peripheral device 2 are paired with the wireless transceiver 1, the peripheral device 2 can automatically select the wireless communication module corresponding to maximum wireless signal strength to establish a wireless connection with the wireless transceiver 1, so that the peripheral device 2 can automatically select the wireless communication module with the best communication quality to establish a wireless connection with the wireless transceiver 1 according to different environments.

### BENEFICIAL EFFECTS OF THE EMBODIMENTS

In conclusion, in the wireless communication pairing system and the wireless communication pairing method provided by the present disclosure, as long as one of the wireless communication modules of the peripheral device is paired with the wireless transceiver, others of the wireless communication modules that have not been paired with the wireless transceiver can be automatically paired with the wireless transceiver, which can eliminate the trouble of repeated manual pairing operations.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wireless communication pairing system, comprising:
a wireless transceiver;
a peripheral device, including a control circuit and a plurality of wireless communication modules, wherein the control circuit is connected to the wireless communication modules, and the control circuit is configured to perform the following operations:
pairing one of the wireless communication modules with the wireless transceiver;
in response to pairing the wireless communication module with the wireless transceiver, obtaining, by the wireless communication module that has been paired with the wireless transceiver, a plurality of pairing records for pairing with others of the wireless communication modules that have not been paired with the wireless transceiver from the wireless transceiver; and
pairing the others of the wireless communication modules that have not been paired with the wireless transceiver with the wireless transceiver according to the pairing records.

2. The wireless communication pairing system according to claim 1, wherein the wireless transceiver includes a plurality of different wireless communication modules, and each of the pairing records includes communication protocol information of the wireless communication module of the wireless transceiver and identity identification information of the wireless communication module of the wireless transceiver.

3. The wireless communication pairing system according to claim 2, wherein each of the wireless communication modules of the peripheral device includes a wireless communication circuit and an antenna, and the wireless communication circuit is connected to the control circuit and the antenna.

4. The wireless communication pairing system according to claim 1, wherein the wireless transceiver includes a storage circuit, the storage circuit is configured to store a plurality of pairing records from the peripheral device, each of the pairing records from the peripheral device includes communication protocol information of the wireless communication module of the peripheral device and identity identification information of the wireless communication module of the peripheral device.

5. The wireless communication pairing system according to claim 1, wherein the wireless transceiver includes a control circuit, a plurality of different wireless communication modules and a connection port, the control circuit of the wireless transceiver is connected to the wireless communication modules of the wireless transceiver and the connection port of the wireless transceiver.

6. The wireless communication pairing system according to claim 1, further comprising a host, wherein the wireless transceiver is connected to the host, the wireless transceiver is configured to obtain a plurality of pairing records of the wireless communication modules of the peripheral device and transmit the pairing records of the peripheral device to the host, and the host is configured to transmit the pairing records of the peripheral device to a cloud server.

7. The wireless communication pairing system according to claim 1, wherein the control circuit of the peripheral device is configured to determine a wireless signal strength between each of the wireless communication modules and the wireless transceiver, and select the wireless communication module corresponding to a maximum wireless signal strength to wirelessly communicate with the wireless transceiver.

8. The wireless communication pairing system according to claim 1, wherein the wireless communication modules include a BLUETOOTH communication module and a 2.4 GHz communication module.

9. The wireless communication pairing system according to claim 1, wherein the peripheral device further includes a wired transmission module.

10. A wireless communication pairing method, comprising:
providing a wireless transceiver and a peripheral device including a plurality of wireless communication modules;
pairing one of the wireless communication modules with the wireless transceiver;
in response to pairing the wireless communication module with the wireless transceiver, obtaining, by the wireless communication module that has been paired with the wireless transceiver, a plurality of pairing records for pairing with others of the wireless communication modules that have not been paired with the wireless transceiver from the wireless transceiver; and
pairing the others of the wireless communication modules that have not been paired with the wireless transceiver with the wireless transceiver according to the pairing records.

11. The wireless communication pairing method according to claim 10, wherein the wireless transceiver includes a plurality of different wireless communication modules, and each of the pairing records includes communication protocol information of the wireless communication module of the and identity identification information of the wireless communication module of the wireless transceiver.

12. The wireless communication pairing method according to claim 10, further comprising: storing, by a control circuit of the wireless transceiver, a plurality of pairing records from the peripheral device in a storage circuit of the wireless transceiver, wherein each of the pairing records from the peripheral device includes communication protocol information of the wireless communication module of the peripheral device and identity identification information of the wireless communication module of the peripheral device.

13. The wireless communication pairing method according to claim 10, further comprising: transmitting a plurality of pairing records from the peripheral device to a host by the wireless transceiver; and the transmitting the pairing records of the peripheral device to a cloud server by the host.

14. The wireless communication pairing method according to claim 10, wherein a control circuit of the peripheral device is configured to determine a wireless signal strength between each of the wireless communication modules and the wireless transceiver, and the control circuit selects the wireless communication module corresponding to a maximum wireless signal strength to wirelessly communicate with the wireless transceiver.
